(19) United States
(12) Patent Application Publication
(10) Pub. No.: US 2012/0182543 A1
(43) Pub. Date: Jul. 19, 2012

(54) Method for Determining Weights of Eggs, and Apparatus

(76) Inventors: Josse De Baerdemaeker, Leuven (BE); Bart Kemps, Leuven (BE); Marjo De Krijger, Amersfoort (NL)

(21) Appl. No.: 13/377,169

(22) PCT Filed: Jun. 10, 2010
(86) PCT No.: PCT/NL2010/050353

§ 371 Date: Mar. 30, 2012

(30) Foreign Application Priority Data
Jun. 11, 2009 (EP) 09007728.0

(51) Int. Cl. A01K 43/00

(52) U.S. Cl. 356/54

(57) ABSTRACT

The present invention relates to a method for determining weights of eggs, comprising,—exposing the eggs to electromagnetic radiation having a wavelength of at least 200 nm and thereby illuminating and/or candling the eggs,—recording and processing images that are obtained from differences in intensity of radiation transmitted during illuminating and/or candling, whereby image data and/or derivatives thereof are established, wherein the method furthermore comprises at least a second type of detection, wherein in combination with the image data and/or derivatives thereof the weight of each egg is obtained. The proposed second manner of detection is preferably either a detection method utilizing a vibration analysis or a method in which a specific form of image processing and image analysis is used. Furthermore, the invention relates to devices suitable for these detection methods, as well as to apparatuses, such as sorting machines, where these devices are used.

The present invention relates to a method for determining weights of eggs, comprising
exposing the eggs to electromagnetic radiation having a wavelength of at least 200 nm and thereby illuminating and/or candling the eggs,
recording and processing images that are obtained from differences in intensity of radiation transmitted during illuminating and/or candling, whereby image data and/or derivatives thereof are established.

In ‘Wiskundig broeden op een ei’, A. Heck, 2004, it is explained at length how the volume of eggs can be determined from photographs of these eggs. Besides an explanation of the mathematical modeling of the volume of an egg, an egg diameter is determined from a photograph in a generally known manner, whereupon furthermore, in accordance with considerations of symmetry, the egg volume (V) is determined. With this, in a manner known to one skilled in the art, the egg weight (or also the egg mass (m)) can be determined by combining the volume with values, for example known from the literature, for the density (ρ), or also the average density, according to m=ρ.V.

This manner of weight determination cannot be simply applied in the art of sorting eggs, because greater accuracies are required there than can be obtained with density values as mentioned above.

In EP1856971 a method and apparatus are described whereby newly-laid and then collected eggs are counted. These counts are carried out on the basis of image recognition with cameras, in the context of which especially the avoidance of double counts is elucidated. In a further elaboration of this image recognition, determining the weight of a counted egg is mentioned. With the aid of these determinations, overviews of the weights of the counted eggs can be compiled, allowing the status of the processes in the poultry houses to be monitored better and control of the poultry houses to be improved.

Such a method and apparatus can be used for determining the weights of passing eggs, and hence for further sorting of these eggs. As is generally known, eggs are sorted, inter alia by weight, where especially the exact weight distribution of these eggs, more specifically their distribution over the well-known weight classes S-M-L-XL, etc., is of crucial importance. More particularly, a sophisticated division of the eggs by their weights precisely around the limits of these weight classes is of great importance. This importance is directly related to the financial proceeds of a batch of eggs.

Determining the weights according to EP1856971 is not sufficient for precision sorting as described above.

To enhance the accuracy of the weight determination, the method according to the present invention is characterized in that the method furthermore comprises at least a second type of detection, wherein in combination with the above-mentioned image data and/or derivatives thereof the weight of each egg is obtained.

Aspects of the invention concern, for example, utilization of a second type of measurement, for taking into account details of the eggshell (for example, shell thickness) and/or of the egg air cell, to meet the need for enhanced accuracy, which will be further elucidated below.

The invention can also be defined as follows: method for determining weights of eggs, comprising
using a first type of egg detection, comprising making images of the eggs utilizing electromagnetic radiation having a wavelength of at least 200 nm;
using a second type of detection to detect the eggs; and
processing detection results of both the first type of detection and the second type of detection for determining the weights.

Detection results of the first type of detection comprise in particular the images of the eggs (in particular, images obtained from differences in intensity of radiation transmitted in illuminating and/or candling), for example image data. The term ‘detection results’ should herein be understood to include ‘derivatives of detection results’.

Detection results of the second type of detection depend on the kind of detection, and comprise, for example, stiffness in the case of stiffness detection, or images of an air cell and/or eggshell obtained with X-ray radiation in the case of X-ray detection.

More particularly, exemplary embodiments of this invention have one or more of the following features:

that the second type of detection comprises determining at least the stiffness K and/or derivatives thereof of the eggshell of each egg as a result of a pressure force changing in time exerted on the eggshell;
that such an egg is caused to vibrate with a tapper unit, wherein at least the stiffness K and/or derivatives thereof are determined from the vibration characteristics of the egg, wherein thereupon the weight of the egg is determined by combining the image data and/or derivatives thereof (i.e., measuring results of the first type of detection concerning the egg) with the shell stiffness and/or the derivatives thereof.

Furthermore, a further elaboration of the invention comprises a second type of detection wherein such egg is caused to vibrate with a tapper unit, wherein at least the stiffness K and/or derivatives thereof are determined from the vibration characteristics of the tapper unit, wherein thereupon the weight of the egg is determined by combining the image data and/or derivatives thereof (i.e., measuring results of the first type of detection concerning the egg) with the shell stiffness and/or the derivatives thereof.

Since in the current egg sorting machines eggs are practically always tested for breakage with the aid of vibration analysis, the exemplary embodiments mentioned above have the great advantage that the same analysis data can be used for weight determination. Furthermore, as a result, detectors for weighing, viz. in general weighbridge devices such as load cells, can be omitted, whereby a further possibility of pollution is obviated and hence an improvement of hygiene is obtained.

In particular, it is known in this field of technology to test the shells of the eggs by subjecting them to a controlled pressure force. In EP738888 the eggs are tapped with a tapper of which a bouncing ball body generates signals that are indicative of the local eggshell status of such an egg. According to EP1238582 the eggshells are also tested, but in contrast to EP738888 the vibration modes of the eggs as a whole are mapped. In NL1018940 it is explained how from the obtained vibration characteristics specific mechanical properties of these eggs can be derived. NL1018940 is incorporated in its entirety into the present application by reference.

In other exemplary embodiments, the method according to the invention has one or more of the features:

that the second type of detection comprises exposing the eggs to X-rays whereby at least data of the air cell of each egg are obtained, wherein the weight (of the egg) is determined by combining the image data and/or derivatives thereof (i.e., measuring results of the first type of detection) with the data of the air cell; and/or
that the second type of detection comprises exposing the eggs to X-rays whereby at least data of the eggshell of each egg are obtained, wherein the weight is determined by combining the image data and/or derivatives thereof (i.e., measuring results of the first type of detection) with the data of the eggshell,
that the X-rays have a wavelength of at most 5 nm for therewith candling the eggs,
wherein images are recorded of differences in intensity of radiation transmitted during candling, and
wherein these images are processed whereby at least transitions and/or features derived therefrom in substantially density are established;
   that the X-ray radiation comprises substantially radiation of the line spectrum type;
   that the X-ray radiation comprises substantially radiation of the continuous spectrum type; and/or
   that the X-ray radiation comprises radiation of both the continuous spectrum and of the line spectrum type.

With great advantage, the above-defined method can be used with generally known apparatuses for medical applications of X-rays. These are understood to include, for example, units as set up for dental checks, these units being built into very compact housings.

In particular, X-rays are used in EP08022372.0, also in applicant's name, in which also with X-rays details of the structure of the egg are established to thereby enable precision determinations of the weight of such an egg. That apparatus and method, however, cannot be used for quick measurements.

In addition, the invention relates to a method for classifying eggs, comprising,
using the method according to at least one of the preceding definitions, and
comparing at least the weights established according to the foregoing with criteria drawn up for classifying.

Furthermore, the method according to the invention relates to the sorting of eggs, comprising,
classifying eggs as defined above, and
in accordance with the classifying, sorting the eggs, wherein the eggs are collected in packing units, and has as a further feature that the eggs are located on rotating rollers of an egg sorting machine.

In addition, these methods can be directly implemented in devices, so that the invention furthermore relates to a device for classifying eggs according to the method according to any one of the above-given definitions. These devices for classifying are deployed according to the invention in sorting apparatuses for eggs.

Hereinbelow, the invention will be described in detail with reference to a drawing, with

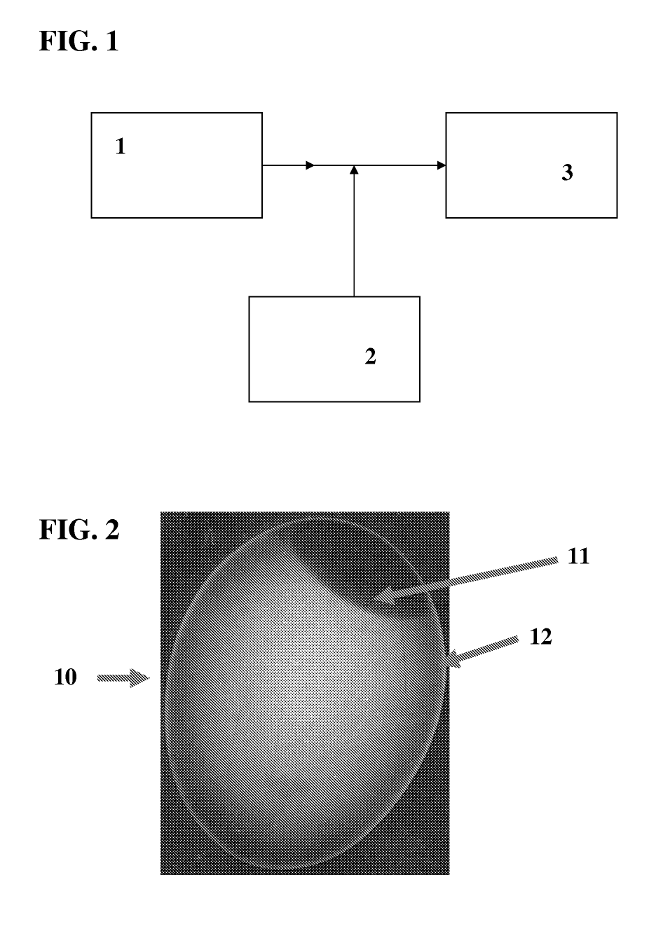

FIG. 1, as a diagram for the method according to the present invention, and

FIG. 2, with an X-ray recording made with a generally known camera for medical applications.

FIG. 1 shows schematically an example of a method for determining weights of eggs, comprising (step 1) using a first type of egg detection, comprising making images of the eggs utilizing electromagnetic radiation having a wavelength of at least 200 nm; (step 2) using a second type of detection to detect the eggs; and (step 3) processing detection results of both the first type of detection and the second type of detection for determining the weights.

FIG. 1 is thus a highly schematic representation of the consecutive steps according to the present method for determining—in a different manner than mechanically—the weight or the mass of an egg. To avoid any confusion, it is noted here that mass and weight herein have the same meaning, since in the use of the present technology, physically speaking, no special circumstances occur that could necessitate making a distinction between mass and weight. The mass, or the weight, will be designated, if necessary, with the symbol ‘m’.

In FIG. 1 the first step of the method according to the invention is represented with block 1. This step involves optically imaging an egg. Optically is understood to mean the use of the electromagnetic spectrum in substantially the visible region, in particular at wavelengths from 200 nm. Imaging will be understood to mean to observe the object, that is, the egg, with the observation being recorded in a manner generally known to one skilled in the art.

Recording will generally involve a camera but can also comprise scanning with a beam. In all these cases the observation will make it possible to determine the circumference. This circumference—in view of the fact that in the great majority of cases the shape of the egg is practically symmetrical, viz. symmetrical around the long axis of the egg—will make it possible to determine the volume of the egg in a simple manner. There where the deviation from the symmetry proves too large, the circumference, for example as a contour, is used for further determinations.

As already indicated above, thereupon the mass or the weight can be determined in a generally known manner, i.e., utilizing measuring results, for example an egg circumference, from the first type of detection. As mentioned, it holds then that in a generally known manner the egg volume (V) is determined from the egg circumference (egg diameter). With this, the egg weight (or also the egg mass (m)) can be determined by combining the volume with values, for example known from literature, for the density (ρ), or also the average density, according to m=ρ.V.

As described hereinbefore in the introduction, this determination is insufficient for the above-mentioned application of accurate sorting. To remedy this deficiency, in the diagram a block 2 is shown which represents a second step in the method according to the invention. This second step is a second detection whereby the deficient accuracy of the first detection is met. With it, in particular, further details of the egg body, viz. the air cell and/or the eggshell, will be determined. Further, it has been found that differences in compositions of substantially egg fluid substantially formed by the egg white and the egg yolk are not relevant to the above-mentioned accuracy required for sorting.

It has been found that this second step (2) can be carried out in several different ways. A first possibility is to determine the vibration properties of such an egg. More particularly, the stiffness K can be determined. This possibility has already been elucidated hereinabove in the discussion of NL1018940. Wholly different from the dynamic properties of such a physical body is one of the derived properties, the thickness of the eggshell.

As mentioned, the egg may for example be caused to vibrate with a tapper unit, with at least the stiffness K and/or derivatives thereof being determined from the vibration characteristics of the egg. Also, the egg may be caused to vibrate with a tapper unit, with at least the stiffness K and/or derivatives thereof being determined from the vibration characteristics of the tapper unit.

As follows from NL1018940, with the stiffness K the thickness T of the eggshell can be determined. With this, as indicated schematically with block 3 in FIG. 1, in combination with the determinations according to block 1, the weight determination as elucidated above can be so adjusted that the accuracy then attained in many cases is sufficient for the application of accurate sorting.

In a further exemplary embodiment for the above-mentioned second step according to block 2, an X-ray image of such an egg is used. In particular in FIG. 2 an example is represented. The photograph shown is made with generally known camera systems for medical applications. The X-ray radiation used there will have a wavelength of at most 5 nm. This technology has meanwhile been developed so far that well-shielded cameras and quick real time data processing are possible. In this photograph of an egg 10, both the air cell 11 and the shell 12 can be seen. Also for this manner of measurement, it has been found that in combination with a volume determination according to block 1 (as described above), the geometric properties of the shell and the air cell can be determined such that with well-known reference values for densities, for example in combination with a statistic calculation model, the weight of such an egg can be determined very accurately according to the step as represented in block 3.

To one skilled in the art it will be clear that small changes and variants are understood to be covered by the scope of the appended claims. By using, for example, details of contrasts in camera pictures, correspondingly more details and refinements in the determinations of the weight can be realized.

1. A method for determining weights of eggs, comprising,
exposing the eggs to electromagnetic radiation having a wavelength of at least 200 nm and thereby illuminating and/or candling the eggs,
recording and processing images that are obtained from differences in intensity of radiation transmitted during illuminating and/or candling, whereby image data and/or derivatives thereof are established,
characterized in that
the method furthermore comprises at least a second type of detection, wherein in combination with said image data and/or derivatives thereof the weight of each egg is obtained.

2. A method according to claim 1, characterized in that said second type of detection comprises determining at least the stiffness K and/or derivatives thereof of the eggshell of each egg as a result of a pressure force changing in time exerted on said eggshell.

3. A method according to claim 2, characterized in that such an egg is caused to vibrate with a tapper unit, wherein at least said stiffness K and/or derivatives thereof are determined from the vibration characteristics of said egg, wherein thereupon the weight is determined by combining said image data and/or derivatives thereof with said shell stiffness and/or said derivatives thereof.

4. A method according to claim 2, characterized in that such an egg is caused to vibrate with a tapper unit, wherein at least said stiffness K and/or derivatives thereof are determined from the vibration characteristics of said tapper unit, wherein thereupon the weight is determined by combining said image data and/or derivatives thereof with said shell stiffness and/or said derivatives thereof.

5. A method according to claim 1, characterized in that said second type of detection comprises exposing the eggs to X-rays whereby at least data of the air cell of each egg are obtained, wherein the weight is determined by combining said image data and/or derivatives thereof with said data of the air cell.

6. A method according to claim 1, characterized in that said second type of detection comprises exposing the eggs to X-rays whereby at least data of the eggshell of each egg are obtained, wherein the weight is determined by combining said image data and/or derivatives thereof with said data of the eggshell.

7. A method according to claim 5, characterized in that the X-rays have a wavelength of at most 5 nm for therewith candling the eggs,
wherein images are recorded of differences in intensity of radiation transmitted during candling, and
wherein these images are processed whereby at least transitions and/or features derived therefrom in substantially density are established.

8. A method according to claim 5, characterized in that the X-ray radiation comprises substantially radiation of the line spectrum type.

9. A method according to claim 5, characterized in that the X-ray radiation comprises substantially radiation of the continuous spectrum type.

10. A method according to claim 5, characterized in that the X-ray radiation comprises radiation of both the continuous spectrum and of the line spectrum type.

11. A method for classifying eggs, comprising,
using the method according to claim 1, and
comparing at least the weights established according to the foregoing with criteria drawn up for classifying.

12. A method for sorting eggs, comprising,
classifying eggs according to claim 11, and
in accordance with said classifying, sorting the eggs, wherein the eggs are collected in packing units.

13. A method according to claim 12, characterized in that the eggs are located on rotating rollers of an egg sorting machine.

14. A device for classifying eggs according to the method of claim 11.

15. An apparatus for sorting eggs according to the method of claim 12.
